(19) United States
(12) Patent Application Publication
(10) Pub. No.: US 2006/0293822 A1
(43) Pub. Date: Dec. 28, 2006

(54) Predictive control method and apparatus for vehicle automatic transmission

(75) Inventors: Frank Lattemann, Portland, OR (US); Felix Kauffmann, Stuttgart (DE); Dieter Reckels, Portland, OR (US)

Correspondence Address: CROWELL & MORING LLP;INTELLECTUAL PROPERTY GROUP, P.O. BOX 14300, WASHINGTON, DC, 20044-4300, US

(73) Assignee: FREIGHTLINER LLC, Portland, OR (US)

(21) Appl. No.: 11/166,735

(22) Filed: Jun. 27, 2005

(51) Int. Cl. G06F 17/00

(52) U.S. Cl. 701/51; 701/207

(57) ABSTRACT

In a method and apparatus for controlling an automatic transmission in a motor vehicle, a vehicle simulation device uses information regarding current vehicle operating parameters, together with map information regarding a route being traveled by the vehicle to project the dynamic longitudinal behavior of the vehicle, including vehicle velocity for the road that lies ahead. An evaluation module utilizes speed profile information generated in this manner to develop a desired torque. Finally, a shift strategy module converts the desired torque into a desired gear and a point in time for shifting, such that the transmission either shifts into neutral or shifts to an appropriate gear. The invention may be implemented in the form of hardware components, in the form of software modules which are run on either a centralized or distributed vehicle control system, or a combination of hardware and software components.

### CROSS REFERENCE TO RELATED APPLICATIONS

This application is related to co-pending U.S. patent application Ser. No. 10/264,253, filed Oct. 4, 2002.

### BACKGROUND OF THE INVENTION

The present invention is directed to a method and apparatus for controlling an automatic transmission in a motor vehicle, based on present and future road and traveling parameters.

In conventional automatic transmissions, including those used in heavy commercial vehicles, gear selection and shifting strategy are based on the current instantaneous conditions which affect the vehicle. Principal among these are the earth's gravitational pull and current slope of the road surface. Thus, if for example the vehicle is currently traveling on a downhill grade, gravitational forces tend to cause it to accelerate, while on uphill grades, the vehicle tends to decelerate. Ordinarily, this means that the transmission shifts to a lower gear on uphill road segments, in order to accommodate the gravitational forces that oppose forward movement of the vehicle. On the other hand, on downward slopes, the transmission has two alternatives: it may shift to a lower gear in order to slow the vehicle, and prevent it from speeding; or under some circumstances, when motive force from the engine is not needed (such as in the case of gentle downward slope), the automatic transmission may shift into neutral in order to conserve fuel.

In all events, however, in conventional automatic transmission controls, decisions regarding gear selection and gear shifting are made taking into account only the current operating circumstances of the vehicle, including its speed and the gravitational force that pulls the vehicle downhill. Thus, if the vehicle enters a short, but steep, downhill segment, the transmission is likely to shift to a lower gear, only to correct its action a few meters later when the road levels out. Or if the transmission shifts into neutral on a short gentle downward slope, it may shortly thereafter shift back into gear when the current instantaneous operating conditions change (that is, the slope of the road becomes steep, the road becomes substantially level, or the vehicle enters an uphill segment). Such frequent and unnecessary shifting is wasteful in that it increases fuel costs and causes additional wear on the engine and transmission. It is also inconvenient and uncomfortable for the driver in terms of unnecessary shifting and additional noise.

A feature known as Eco-Roll™, which is currently commercially available, is described in Commercial Motor, 27 February-5 March edition. The Eco-Roll™ system is activated when the vehicle cruise control is engaged and the transmission is operated in the full auto mode. Under certain defined circumstances it effectively disengages the gear box by putting the splitter into neutral, allowing the vehicle to “free wheel” and save fuel. In particular, when the vehicle engine control unit determines that there is no current need for either motive power or engine braking (neither the brake pedal nor the accelerator pedal is depressed) and certain other conditions are met, it engages Eco-Roll™. The system is thereafter deactivated whenever the driver signals a need for engine power or braking, by depressing either the accelerator or brake pedal or engaging the vehicle engine brake. The gearbox is thus once again engaged.

As with other prior art transmission controls, however, the Eco-Roll system is responsive only to currently existing driving conditions, with decisions regarding automatic engagement or disengagement of the gear box being made based on the status of certain vehicle control inputs which are manipulated by the driver. Moreover, driver intervention is required (in the form of manipulation of the brake or accelerator pedals, etc.) in order to return the transmission gearbox from a disengaged state to an engaged state.

Published U.S. patent application No. 2004-0068359A1 discloses a predictive cruise control system which utilizes information about the terrain ahead of the vehicle in order to control its speed. For this purpose, a vehicle operating cost function is defined, based on a plurality of environmental parameters, vehicle parameters, vehicle operating parameters and route parameters. As the vehicle proceeds, an onboard computer iteratively calculates optimal vehicle parameters for controlling the vehicle throttle in such a way as to maintain the speed of the vehicle within a speed band.

One object of the present invention is to provide an automatic transmission control system which avoids unnecessary gear changes on routes with rapidly changing topography.

Another object of the invention is to improve the performance of the vehicle transmission on downhill road segments, in terms of fuel economy, wear on the transmission and brakes, and operator comfort.

Another object of the invention is to provide such an automatic transmission control system which takes into account both present and predicted vehicle operating parameters in order to select an appropriate gear and/or to control gear shifting of the transmission, especially (but not necessarily exclusively) on downhill road segments.

Still another object of the invention is to provide an automatic transmission control system that uses information regarding the road ahead of the vehicle to control gear selection and shifting.

These and other objects and advantages are achieved by the method and apparatus according to the invention, in which a vehicle simulation device uses information regarding current vehicle position and operating parameters together with map information regarding a route being traveled by the vehicle to project the dynamic longitudinal behavior of the vehicle, including vehicle velocity for the road that lies ahead. An evaluation module then utilizes speed profile information generated in this manner to develop a desired torque. Finally, a shift strategy module converts the desired torque into a desired gear and a shifting time point, such that the transmission either shifts into neutral or shifts to the appropriate gear.

As the road profile is taken into account, the action taken is appropriate for downhill. Thus, for example, if current conditions alone would call for a downshift, but the slope of the road changes substantially in a few meters, the system according to the invention would not ordinarily downshift. In this manner unnecessary gear shifting is avoided, so that fuel consumption and wear on the system are reduced, while ride comfort of downhill traveling is increased.

As is apparent to those skilled in the art, the predictive transmission control system according to the invention may be implemented as separate hardware components as shown by way of the illustrative examples herein. It may also be implemented, however, in the form of software modules which are run on either a centralized or distributed vehicle control system; or it may be implemented by a combination of hardware and software components, all of which are within the scope of the invention.

Other objects, advantages and novel features of the present invention will become apparent from the following detailed description of the invention when considered in conjunction with the accompanying drawings.

### BRIEF DESCRIPTION OF THE DRAWINGS

FIG. 1 is a conceptual block diagram which shows the communication among components of a predictive transmission control system in a vehicle which includes a communication bus; and

FIG. 2 is a block diagram of a predictive transmission control module according to the invention.

### DETAILED DESCRIPTION OF THE DRAWINGS

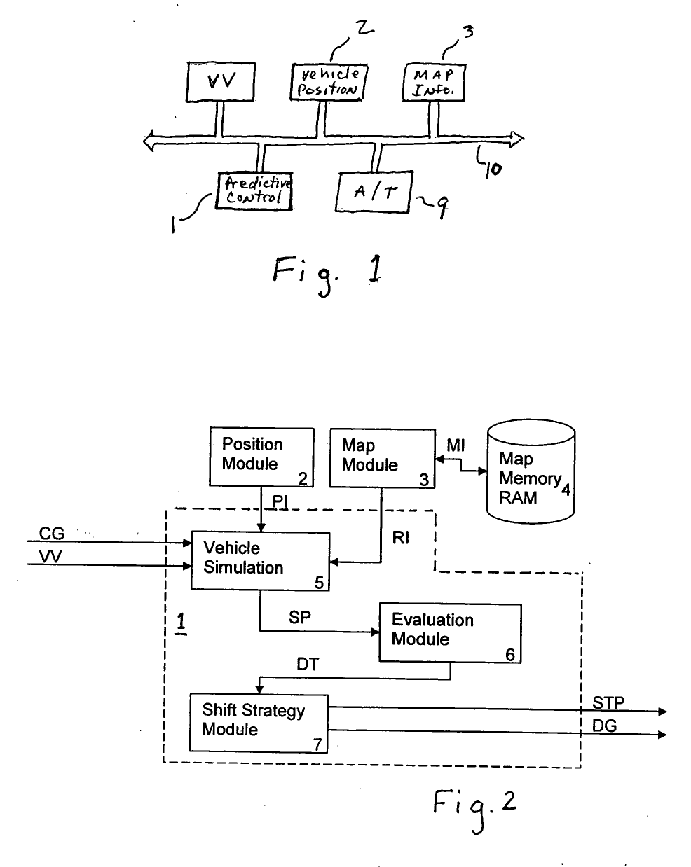

FIG. 1 is a conceptual diagram which illustrates the elements of the predictive transmission control system according to the invention. A conventional vehicle communication bus 10 provides communications among numerous controllers, sensors and actuators commonly found in vehicles. (Components that are unrelated to the present invention are not shown.) As relevant to the present invention, the automatic transmission 9, communicates with other vehicle components, including the control unit 1, via the communications bus 10, including the transmission of current gear information and the receipt of shift commands. The control unit, on the other hand, receives current gear information from the automatic transmission, as well as current vehicle position and velocity information and map information via the communication bus, and transmits command signals which are received and implemented by the automatic transmission 9. Such bus communications systems are well known, and require no further explanation to those skilled in the art.

FIG. 2 shows the configuration of a predictive control module 1 for implementing vehicle transmission control according to the invention. (Components which correspond to those in FIG. 1 has the same reference numerals.) The predictive control module receives information regarding current gear (CG) and vehicle velocity (VV) transmitted via the vehicle communication bus as depicted in FIG. 1. In addition, it also receives information regarding the current location of the vehicle from the position module 2, and information regarding the topography and course of the road ahead (for example, over a distance of about 30 seconds' travel, or about 750 m at 25 m/sec) from the map module 3. For the latter purpose, a map memory 4 has stored therein a digital map of the area in which the vehicle is operated, which includes both route information and elevation information. (Because a position module and a map module are frequently included on vehicles for other purposes, including vehicle navigation, they are shown here as separate components. It is of course apparent that they may also be incorporated into the predictive control module itself, if such information is not otherwise available.)

Within the predictive control module, a vehicle simulation unit 5 utilizes the current position information from the position module 2 to retrieve road information from the map module 3, based on map data stored in the RAM 4. The latter information, including road gradient for the route forward of the vehicle is then used, together with current gear data CG and current vehicle velocity information VV, to compute the vehicle velocity for the road that lies ahead as a function of the vehicle's forward movement. That is, the vehicle simulation unit 5 models the longitudinal dynamic behavior of the vehicle based on this information, using conventional and well known equations of motion. For this purpose, it is assumed that the vehicle cruise control remains operative.

Information regarding the projected vehicle dynamic behavior is then provided to an evaluation module 6 in the form of speed profile calculations SP. The evaluation module evaluates the speed profile calculations and computes a resulting desired torque DT for the road ahead for which the map information has been evaluated in the vehicle simulation unit 5.

Finally, the shift strategy module 7 used the desired torque signal DT to determine desired gear information DG and a shifting time point STP, which it sends to the automatic transmission 9 (FIG. 1) to control its operation. In this manner the predictive transmission control is able to predict the appropriate shifting strategy from the top of a downhill road segment, and even before. Fuel consumption and wear on the transmission can thus be reduced, and driver comfort enhanced, by eliminating improvident and unnecessary gear shifting.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. A method of controlling shifting of an automatic transmission in a vehicle, said method comprising:
determining a current geographic position of the vehicle;
reading projected road contour information from a memory for an approaching portion of a traveled route which lies ahead of the vehicle, based on said determined current position; and
controlling at least one of gear selection and gear shifting timing of said automatic transmission, based on said projected road contour information.

2. The method according to claim 1, wherein said step of controlling shifting comprises:
modeling projected dynamic longitudinal behavior of the vehicle for an approaching portion of the traveled route, based on said projected road contour information, to determine a projected vehicle speed profile;
based on said projected vehicle speed profile, computing a projected desired torque profile;
converting said desired torque profile into desired gear information and shifting timing information;
and controlling said automatic transmission according to said desired gear and shifting timing information.

3. The method according to claim 2, further comprising:
detecting current vehicle speed and current vehicle gear position;
wherein said modeling step takes current vehicle speed and gear position into account to determine said projected vehicle speed profile.

4. The method according to claim 2, wherein said step of controlling said automatic transmission comprises:
shifting said transmission when projected road contour information for a road segment immediately ahead of said vehicle warrant such a shift; and
inhibiting shifting of said transmission when projected road contour information for a road segment beyond the road segment immediately ahead of said vehicle does not warrant such a shift or would warrant reversal of such a shift.

5. The method according to claim 4, wherein said step of shifting said transmission comprises:
shifting said transmission into neutral when said road segment immediately ahead of said vehicle exhibits a gradual downhill slope, and shifting said transmission into a lower gear when said road segment immediately ahead of said vehicle exhibits a steep downhill slope.

6. The method according to claim 5, wherein said step of inhibiting shifting comprises:
inhibiting a shift into neutral when a road segment beyond the road segment immediately ahead of said vehicle exhibits a change of grade from a gradual downhill slope, to a steep downward slope or to an upward slope; and
inhibiting a shift into a lower gear when the road segment beyond the road segment immediately ahead of the vehicle exhibits a change from a steep downhill slope to a gradual downward slope.

7. Apparatus for controlling shifting of an automatic transmission in a vehicle, comprising:
a position module which determines a current geographic position of the vehicle;
a map information module which accesses stored map information, including route and elevation data for an area in which said vehicle is operated; and
a predictive shifting control module which reads projected road contour information from said map module for an approaching portion of a traveled route which lies ahead of the vehicle, based on said current geographic position of the vehicle;
wherein said predictive shifting control module controls at least one of gear selection and gear shifting timing of said automatic transmission, based on said projected road contour information.

8. The apparatus according to claim 7, wherein said predictive shifting control module comprises:
a vehicle simulation unit which models projected dynamic longitudinal behavior of the vehicle for an approaching portion of the traveled route, based on said projected road contour information, and determines a projected vehicle speed profile;
an evaluation module which computes a projected desired torque profile based on said projected speed profile; and
a shift strategy module which converts said desired torque profile into desired gear information and shift timing information for controlling said automatic transmission.

9. The apparatus according to claim 8, further comprising:
a sensor for determining a current speed of the vehicle; and
means for determining a current gear position;
wherein said vehicle simulation unit takes current vehicle speed and gear position information into account in determining said projected vehicle speed profile.

10. The apparatus according to claim 8, wherein said predictive shifting control module controls said automotive transmission according to the following shift strategy:
shifting said transmission when projected road contour information for a road segment immediately ahead of said vehicle warrant such a shift; and
inhibiting shifting of said transmission when projected road contour information for a road segment beyond the road segment immediately ahead of said vehicle do not warrant such a shift or would warrant reversal of such a shift.

11. The apparatus according to claim 10, wherein said predictive shifting control module shifts said transmission into neutral when said road segment immediately ahead of said vehicle exhibits a gradual downhill slope, and shifts said transmission into a lower gear when said road segment immediately ahead of said vehicle exhibits a steep downhill slope.

12. The apparatus according to claim 11, wherein said predictive shifting control module:
inhibits a shift into neutral when a road segment beyond the road segment immediately ahead of said vehicle exhibits a change of grade from a gradual downhill slope, to a steep downward slope or to an upward slope; and
inhibits a shift into a lower gear when the road segment beyond the road segment immediately ahead of the vehicle exhibits a change from a steep downhill slope to a gradual downhill slope.
